(19) United States
(12) Patent Application Publication
(10) Pub. No.: US 2005/0067727 A1
(43) Pub. Date: Mar. 31, 2005

(54) Encoded sheet of material and method for controlling an article forming system

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/671,113

(22) Filed: Sep. 25, 2003

(51) Int. Cl. B29C 43/58

(52) U.S. Cl. 264/40.1; 425/136; 425/406

(57) ABSTRACT

A method for controlling the operation of an article forming system by incorporating into the article forming system a monitoring system which reads an identifier disposed on or in a sheet of material. The identifier provides information regarding the sheet of material so as to indicate whether or not the sheet of material relates to a particular category. The operation of the article forming system can then be modified based on the sheet information encoded by the identifier which is read by the monitoring system.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

In the process of forming an article or object using an article forming system, an article producer generally uses an article forming system having an assembly for forming a sheet of material into an article having a predetermined shape and an inner space. Generally, the sheet of material is automatically or manually provided to the article forming system which then forms the sheet of material into the article. Many article forming systems are well known in the art, such as shown for example in U.S. Pat. No. 5,985,187, issued to Weder et al., U.S. Pat. No. 5,795,281, issued to Weder et al., and U.S. Pat. No. 4,773,182, issued to Weder et al., which are expressly incorporated herein by reference in their entireties.

Generally, article forming systems include both mechanical and electrical components and may be controlled by a computer system. In one preferred embodiment, the article forming system is configured to provide the desired article by pressing the sheet of material with a mold, form, or die, generally for a predetermined time, and/or by applying a bonding technique, such as for example a bonding technique using heat, pressure, or light. If an inappropriate or unacceptable sheet of material is supplied to the article forming system, the processing timing, the mold, form, or die used, or the bonding technique may not deform the sheet of material into the article having the shape desired by the article producer, or the sheet of material may not maintain its deformed shape. Further, an inappropriate or unacceptable sheet of material could produce the desired shape but be of defective or undesired quality, or may hinder or damage the article forming system, or may cause the overall mechanized operation to shut down or suffer delays, thereby causing reduced efficiency and excessive costs which must be borne by the article producer. Because the article forming system may be automated, and because human monitors may not be able to detect the inappropriateness or unacceptability of the sheet of material, there is a risk, and potentially additional costs, associated with using inappropriate or unacceptable sheets of material, such as for example producing multiple undesired articles.

Therefore, there is a need for a method for controlling the operation of an article forming system wherein the appropriateness or acceptability of the sheet of material provided to the article forming system can be monitored so as to assure the quality of the article being formed and to assure efficient operation of the system. It is to such an apparatus and method that the present invention is directed.

### BRIEF DESCRIPTION OF THE SEVERAL VIEWS OF THE DRAWINGS

FIG. 1 is an elevational view of a sheet of material constructed for use in the present invention.

FIG. 2 is a cross-sectional view of the sheet of material of FIG. 1.

FIG. 3 is a cross sectional view of another embodiment of a sheet of material constructed for use in the present invention.

FIG. 4 is a cross sectional view of another embodiment of a sheet of material constructed for use in the present invention.

FIG. 5 is an elevational view of a flower pot or flower pot cover constructed in accordance with the present invention.

FIG. 6 is a block diagram of an apparatus constructed in accordance with the present invention.

FIG. 7 is a side elevational, partial sectional view of one embodiment of an article forming system constructed in accordance with the present invention.

### DETAILED DESCRIPTION

Generally, the present invention contemplates an apparatus and method for monitoring a sheet of material of the type described herein so that an appropriate sheet of material can be formed into an article having a desired formed shape and a desired shape retention quality, thereby providing a method for making articles from such sheets of material in a more controlled and desirable manner.

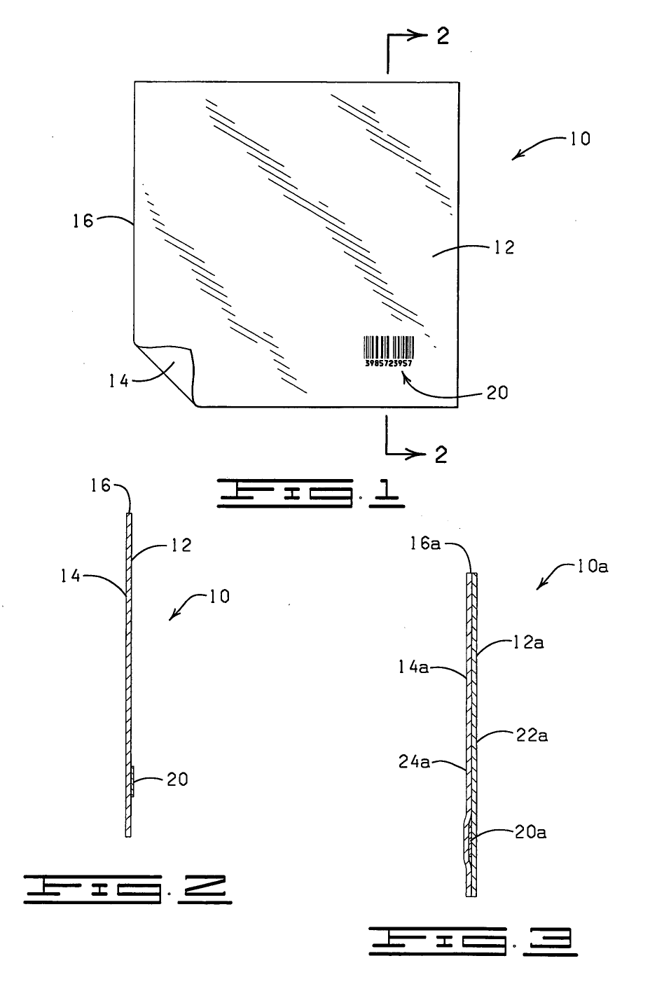

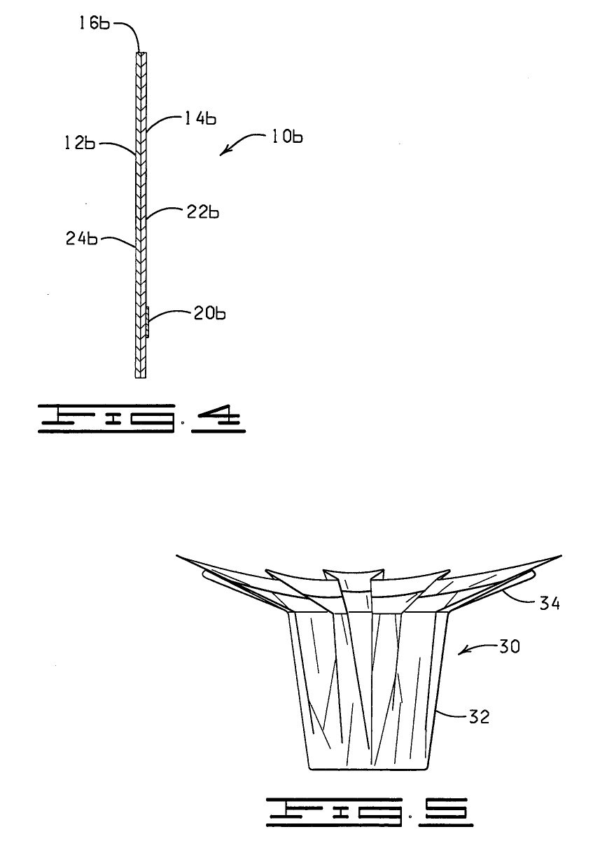

Turning now to the drawings, shown in FIGS. 1 and 2 and referred to therein by the general reference numeral 10 is a sheet of material used in accordance with the present invention. The sheet of material 10 has an upper surface 12, a lower surface 14, and an outer peripheral edge 16. The sheet of material 10 may be constructed of a single layer of material or may be constructed of two or more layers of material laminated together or otherwise connected. The two or more layers of material may be the same size or may be different sizes.

The sheet of material 10 can be constructed from any suitable substance, or combination of substances, capable of being formed to substantially retain or maintain a shape, with or without the use of a bonding material. The sheet of material 10 is preferably constructed of a material selected from a group of materials consisting of treated or untreated paper, metal foil, cloth (natural, synthetic, or combinations thereof), denim, burlap, non-polymeric film, polymeric film, including, polypropylene, polyethylene, polyvinyl chloride, cellophane, ethyl vinyl acetate, polyvinylidene chloride, ethylene vinyl alcohol, polystyrene, polyethylene terephthlate, and cling material, or combinations thereof.

The term “bonding material” when used herein means any pressure or heat activated adhesive or cohesive material, sonic sealable, or vibratory sealable material; heat or chemically shrinkable material; materials sealable by static electricity or other electrical means; magnetic means; mechanical or barb-type fastening means or clamps; curl-type materials or other materials incorporated into the material which can cause the material to take on certain shapes; and any type of welding method which may weld portions of the material to itself or to a container or floral holding material, such as a pot, or to both the material itself and the container. The term “bonding material” when used herein also includes ties, wires, labels, elastic or rubber bands or materials, loops, ribbons, strings, tape, staples, sleeves, overpots or combinations thereof.

Although the sheet of material 10 is shown in FIG. 1 as being generally rectangular in shape, it should be understood that the sheet of material 10 may have any shape, such as a symmetric or an asymmetric shape. For example, the sheet of material 10 may be square, rectangular, circular, or another geometric shape. The sheet of material 10 may also have an irregular, capricious, or decorative shape.

Since in some instances and for various reasons, it may be desirable to utilize more than one sheet of material to form an article, the present invention also contemplates the use of more than one sheet of material 10 in forming an article by an article forming system. In these instances, the sheets of material 10 are typically layered, placed one on the other either aligned or offset, when the sheets of material 10 are formed into the predetermined shape to form the desired article. Also, the present invention contemplates using other sheets of material which are partially pre-shaped which can be further formed by the article forming system into the article having a predetermined shape and an inner space. Examples of partially pre-shaped sheets of material are preformed pot covers known in the art as “SPEED COVERS®”, and “sleeves”, which are generally opened from a flattened position to an open position to contain flower pots, floral groupings, floral holding materials, small objects, or the like, in a decorative manner. Other partially pre-shaped sheets of material which can be used in accordance with the present invention are apparent to one of ordinary skill in the art.

The sheet of material 10 has an identifier 20 disposed thereon or therein. The identifier 20 may be printed on or imprinted into the sheet of material 10, or integral therein, or may be applied as a label or sticker, or may be applied in any other method described elsewhere herein or known by one of ordinary skill in the art. The identifier 20 is preferably disposed on a portion of the upper surface 12 of the sheet of material, as shown for example in FIG. 1. Alternatively, the identifier 20 may be disposed on the lower surface 14, or between the upper surface 12 and lower surface 14.

For example, in an alternate embodiment, shown in FIG. 3, a sheet of material designated by the general reference numeral 10a has an upper surface 12a, a lower surface 14a, and an outer peripheral edge 16a. The sheet of material 10a is constructed of at least a first layer of material 22a and a second layer of material 24a, wherein an identifier 20a is positioned between the first layer of material 22a and the second layer of material 24a and wherein the first layer of material 22a and the second layer of material 24a are laminated or otherwise connected together.

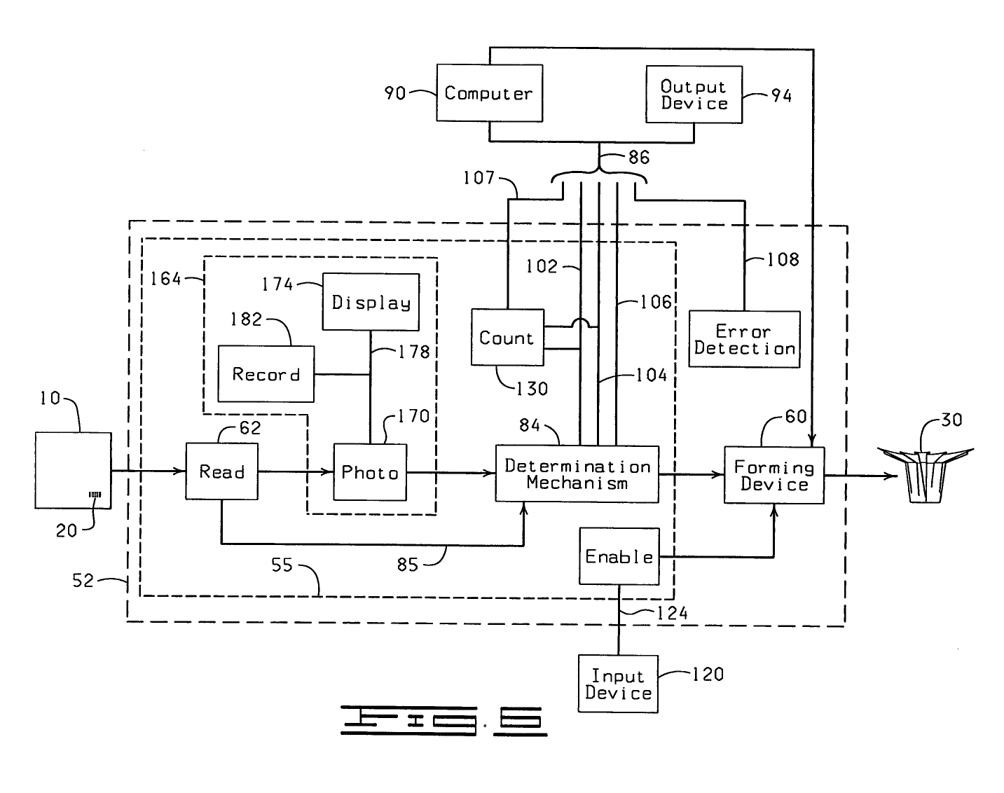

In an alternate embodiment, shown in FIG. 4, a sheet of material designated by the general reference numeral 10b comprises an upper surface 12b, a lower surface 14b, an outer peripheral edge 16b, an identifier 20b, a first layer of material 22b, and a second layer of material 24b which is laminated or otherwise connected to the first layer of material 22b. The sheet of material 10b is similar to the sheet of material 10a except the identifier 20b is disposed upon the lower surface 14b instead of being disposed between the first layer of material 22b and the second layer of material 24b.

It should be understood that the present invention may be operated when a sheet of material is absent an identifier 20, as discussed in further detail below. The sheet of material absent an identifier 20 is essentially the same as the sheet of material 10, or other sheets of material described herein, except that the identifier 20 is absent. Thus, although the article forming system 52 may be described hereinafter generally in conjunction with the sheet of material 10 having the identifier 20 disposed thereon or therein, it should be understood that the article forming system 52 also can operate in conjunction with the sheet of material absent the identifier 20 and, for purposes of clarity, may not be separately discussed when the article forming system operates in a similar manner for both the sheet of material 10 having the identifier 20 and the sheet of material absent the identifier 20.

In preferred embodiments, the identifier 20-20b of the sheet of material 10-10b includes information which is indicative of at least one identifying characteristic of the sheet of material 10-10b, such as for example the source, shape, dimension, coloring, decorative pattern, material of construction, bonding material disposed thereon, structural feature, or potential use of the sheet of material 10-10b. The identifying characteristics indicated by the sheet of material 10-10b can be used to determine if the sheet of material 10-10b relates to a category, or group of categories. For example, the information of the identifier 20-20b can indicate that the sheet of material 10-10b relates to the category including, but not limited to, (1) sheets of material that are one foot square, (2) rectangular sheets with a thickness of 30 mils, (3) red sheets with a lace pattern, (4) sheets made of metal foil, (5) sheets without an adhesive, (6) sheets with drainage holes, or (6) sheets produced by Highland Supply Co. of Illinois. In another example, the encoded information in the identifier 20-20b can indicate that the sheet of material 10-10b relates to a category which includes circular sheets of material having a diameter of two feet. The above examples should be considered illustrative and not limiting of the present invention. A person of ordinary skill in the art would recognize that any one characteristic, or combinations of characteristics, of the sheet of material 10-10b can be indicated by the information of the identifier 20-20b.

In preferred embodiments of the present invention, the identifier 20-20b may be a mark. The mark comprising the identifier 20-20b can be, for example, a bar code, watermark, hallmark, logo, text, word, name, symbol, device, graphic, picture, seal, hologram, color code, magnetic code, chemical tag, nanobarcode, DNA tracer, stacked symbologies, matrix symbologies, and combinations thereof. The identifier 20-20b, including the mark, can be made on or in the sheet of material 10-10b using a marking technique involving an inscribed stamp, photo-luminescent dye, IR up-converter crystals, nanoparticles, laser light, magnetic ink, metallic ink, printing ink, color ink, DNA, chemical infusion, and combinations thereof. Such techniques of making identifiers 20-20b such as marks are well known in the art, therefore no further discussion is deemed necessary to teach one skilled in the art to make the identifier 20.

As noted herein, the sheet of material 10-10b, or any other sheet of material described herein, may be used to form, in one embodiment, a preformed flower pot or flower pot cover, such as shown in FIG. 5 and referred to herein by the general reference numeral 30.

The flower pot cover 30 includes a base 32 and a skirt 34 which extends outwardly or inwardly from the base 32. Although FIG. 5 shows a flower pot cover 30, the present invention contemplates the production of any article having a predetermined shape and inner space which can be formed by the method shown herein, including for example a vase, hat, saucer, Easter basket, container for use in a microwave oven, rose stem box, egg carton, potting tray, pan, tray, bowl, basket liner, candy tray, drinking cup, candy cup, flower pot, planter tray for growing plants, floral holding material, disposable bowl and dish, corsage box and container, food service tray, fast food container, frozen food container, and food services box.

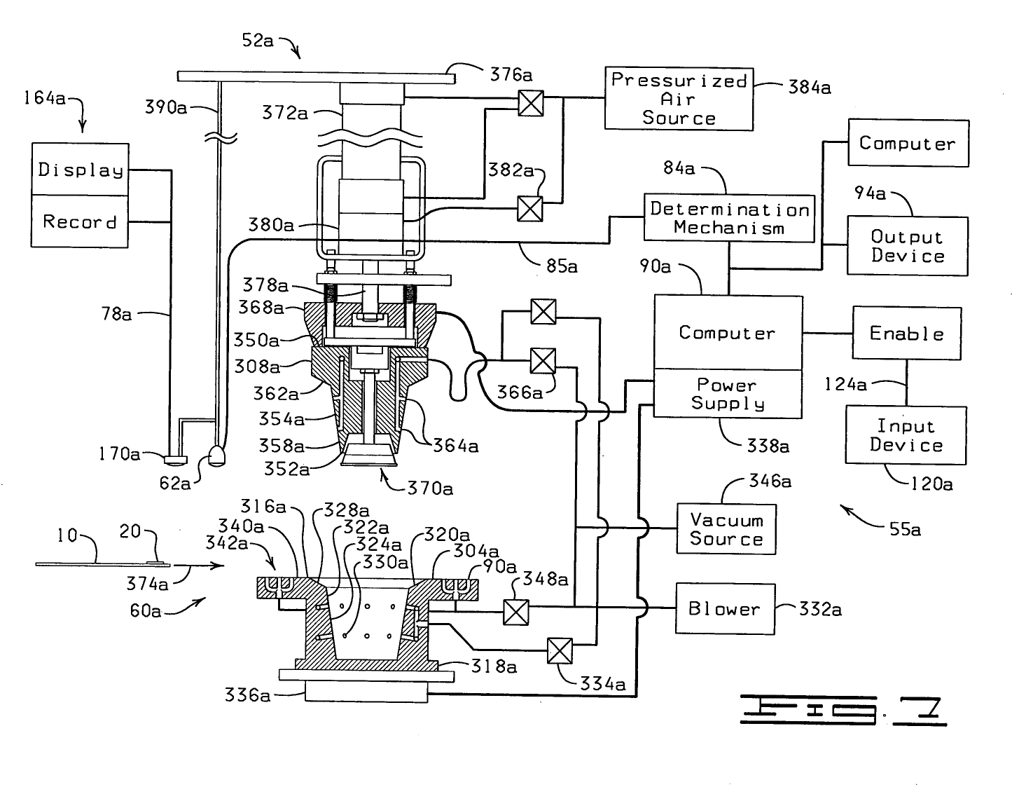

Referring now to FIG. 6, shown therein in schematic form is a controlled article forming system 52 (indicated within an outwardmost dashed box) constructed in accordance with the present invention. The article forming system 52 includes a monitoring system 55 (indicated within a dashed box) and a forming device 60 (e.g., a mold) for forming the sheet of material 10-10b into the flower pot cover 30 or other article having a predetermined shape and an inner space.

The article forming system 52 will be described hereinafter in conjunction with the sheet of material 10. However, it should be understood that the article forming system 52 operates in a similar manner with the sheets of material 10a and 10b or any other sheets of material described or enabled herein.

In general, the monitoring system 55 of the article forming system 52 determines the presence or absence of the identifier 20 on the sheet of material 10 and reads the identifier 20 of the sheet of material 10 when the identifier 20 is present to interpret sheet information encoded by the identifier 20. The monitoring system 55 then uses the sheet information to determine if the sheet of material 10 relates to a category in a predetermined manner. If the sheet of material 10 is determined to not relate to the category, or if the sheet of material 10 is absent the identifier 20, then the operation of the article forming system 52 is preferably modified.

The monitoring system 55 is provided with a reading mechanism 62 for sensing or determining the presence or absence of the identifier 20 on or in the sheet of material 10, and reading and interpreting the identifier 20 of the sheet of material 10 when the identifier 20 is present. In one preferred embodiment, the identifier 20 is a bar code and the reading mechanism 62 comprises at least one bar code scanner (not shown). Such mechanisms capable of determining the presence of bar codes and reading bar codes are well known by one of ordinary skill in the art, therefore no further discussion of the operation of the bar code scanner is deemed necessary herein.

In one embodiment, the sheet information of the identifier 20 comprises encrypted data indicative of at least one characteristic of the sheet of material 10 and the monitoring system 55 further decodes the encrypted data using predetermined decodation rules so as to obtain sheet information from the identifier 20. For example, when the identifier 20 is a bar code, the monitoring system 55 can read the bar code using the bar code scanner and then decode the encrypted data so as to obtain the sheet information from identifier 20. Use of encrypted data and predetermined decodation rules are well known to those of ordinary skill in the art, therefore no further discussion of their operation is deemed necessary herein.

When a plurality of sheets of material 10 are to be sensed and read by the monitoring system 55, the sensing and reading of the identifiers 20 of the sheets of material 10 by the monitoring system 55 is preferably done continuously, wherein for each sheet of material 10, the presence or absence of the identifier 20 is determined and the identifier 20 is read if it is present. Alternatively, the sensing and reading of the identifier 20 of the sheet of material 10 can be performed intermittently, if preferred, at a predetermined non-continuous interval, e.g., every other sheet, every third sheet, etc., or at random intervals, wherein the identifiers 20 of the sheets of materials 10 are sensed and read at random.

The monitoring system 55 further comprises a determination mechanism 84 which determines whether the sheet of material 10 relates to a particular category, or group of categories, preferably in a predetermined manner. For example, the determination mechanism 84 of the monitoring system 55 may determine whether the sheet information derived from the identifier 20 indicates that the sheet of material 10 falls within or outside a particular category. For example, if the category includes sheets of material that are blue in coloring and made of untreated paper, and the identifier 20 of the sheet of material 10 indicates that the sheet of material 10 is blue in coloring and is made of untreated paper, then the determination mechanism 84 of the monitoring system 55 would determine that the sheet of material 10 relates to the category. However, in the above example if the identifier 20 of the sheet of material 10 instead indicates that the sheet of material 10 is red in coloring and is made of metal foil, then the determination mechanism 84 would determine that the sheet of material 10 does not relate to the category.

The determination mechanism 84 can be any automatic or manual device capable of receiving the determination of the presence or absence of the identifier 20 and interpreting the sheet information read by the reading mechanism 62, and determining whether the information interpreted from the identifier 20 of the sheet of material 10 indicates that the sheet of material 10 relates to a category in a predetermined manner. For example, in one embodiment, the determination mechanism 84 can comprise electronic hardware, such as one or more circuits, and/or software, such as one or more computer programs (not shown). In such an embodiment, the determination mechanism 84 can be for example a computer with software which compares the sheet information derived from the identifier 20 to a database representative of one or more categories in determining whether sheet the information interpreted from the identifier 20 of the sheet of material 10 indicates that the sheet of material 10 relates to the category, or group of categories. Alternatively, a human operator can make the determination of whether the sheet information interpreted from the identifier 20 indicates that the sheet of material 10 relates to the category. In one embodiment, the determination mechanism 84 receives the determination of the presence or absence of the identifier 20 and the sheet information interpreted from the identifier 20 by the reading mechanism 62 via a signal line 85 which may be for example, wired or wireless.

If the sheet of material 10 is determined by the determination mechanism 84 to not relate to a selected or predetermined category, or if the sheet of material 10 is absent the identifier 20, then the operation of the article forming system 52 is, in a preferred embodiment, modified. In one preferred embodiment for example, the step of modifying the operation of the article forming system 52 includes the monitoring system 55 outputting a result after reading the identifier 20 and interpreting the sheet information obtained from the identifier 20. The result is indicative of (1) the determination of the presence or absence of the identifier 20 by the reading mechanism 62, (2) the sheet information read from the identifier 20, and/or (3) the determination reached by the determination mechanism 84 of the monitoring system 55. The result may also be outputted if the identifier 20 is present and/or if the sheet of material 10 is determined by the determination mechanism 84 to relate to the category.

The result may be outputted by the determination mechanism 84 of the monitoring system 55 via an output signal path 86 to at least one local or remote computer 90 and/or to at least one local or remote output device 94, such as a printer, monitor, or any other perception device capable of generating an audible or visual response thereto, such as an LED or speaker, or the like (not shown). The result can be utilized, such as for example by a computer program or a human operator, to perform an analysis and/or a side-by-side comparison of the sheet information read regarding the sheet of material 10. Further, the result may be used to configure or reconfigure the article forming system 52, as discussed in further detail below.

The output signal path 86 can be a communication link such as an internet connection, intranet connection, cables, bus, cable network modem, telephone link, network connection, airway link, satellite link, radio link, local area network, wide area network, point-to-point shared and dedicated communication, infra-red link, microwave link, CATV link, fiber-optic link, and combinations or derivations thereof. Further, the output signal path 86 may include a plurality of signal paths. For example, shown in FIG. 6, output signal path 86 comprises a plurality of signal paths 102, 104, 106, 107, and 108.

In one preferred embodiment, the result outputted by the determination mechanism 84 of the monitoring system 55 is a comparison accept signal which indicates that the sheet information derived from the identifier 20 indicates that the sheet of material 10 relates to the category, and/or a comparison reject signal which indicates the absence of the identifier 20 or that the sheet information derived from the identifier 20 indicates that the sheet of material 10 does not relate to the category. The comparison accept signal and/or the comparison reject signal can be used, such as for example by a computer program, a human operator, or the monitoring system 55, to perform an analysis and/or act as a trigger, as discussed in further detail below. For example, the comparison accept signal and/or reject signal can be used in an analysis to determine whether to further modify the operation of the article forming system 52 during real time, or merely for accounting purposes, as discussed in further detail below. The comparison accept signal and the comparison reject signal may be outputted on separate signal paths. For example, the comparison accept signal may be outputted via signal path 102 of output signal path 86 and the comparison reject signal may be outputted via signal path 104 of output signal path 86. However one of ordinary skill in the art would recognize that the comparison accept signal and the comparison reject signal may be outputted onto the same signal path.

In one embodiment, the step of modifying the operation of the article forming system 52 can also include configuring the article forming system 52, for example the forming device 60, so that a particular article or item can be formed, in a particular manner, for example, so that the article formed has a shape appropriate for the sheet of material 10 provided. Configuring the article forming system 52 allows for adjustments to be made to the article forming system 52, for example by the article producer via a computer or human operator, so that the sheet of material 10 read by the monitoring system 55 can be formed into a particular article, or so that another sheet of material 10 relating to the category can be provided. In one preferred embodiment, when the step of modifying the operation of the article forming system 52 comprises outputting the result, as discussed above, the step of modifying the operation of the article forming system 52 further comprises configuring the article forming system 52 after the determination mechanism 84 of the monitoring system 55 outputs the result. This allows for the result, such as for example information about at least one of the source, shape, dimension, coloring, pattern, material, bonding material, structural feature, or potential use of the sheet of material 10, to be used, for example by a computer program or human operator, in configuring the article forming system 52.

In one example of using the result to configure the article forming system 52, wherein the result is outputted to at least one computer 90, the article producer may use a computer program to control the configuration of the article forming system 52 and use the output of a result comprising a comparison reject signal as a trigger to configure the article forming system 52 and further use the result to configure the article forming system 52, such as for example by changing a set parameter, such as a mold or die temperature setting, so as to be appropriate for the sheet of material 10 read by the monitoring system 55.

In another example, the result can be used in configuring the article forming system 52 by outputting the comparison accept signal or the comparison reject signal to an LED display (not shown) wherein a corresponding LED, for example a green LED, will emit a green light if the comparison accept signal is outputted by the monitoring system 55 and another corresponding LED, for example a red LED, will emit a red light if the comparison reject signal is outputted by the monitoring system 55. If a human operator perceives that the green LED is lighted, and therefore the comparison accept signal was outputted by the monitoring system 55, then the human operator will not need to configure or reconfigure the article forming system 52. If however the human operator perceives that the red LED is lighted, and therefore the comparison reject signal was outputted by the monitoring system 55, the human operator will configure or reconfigure the article forming system 52 by making appropriate adjustments to the article forming system 52, such as for example, removing the provided sheet of material 10 from the article forming system 52 or by adjusting a particular parameter (preset or not preset) of the article forming system 52, such as for example the temperature setting of the forming device 60. The above example using the LED display could also be done in a like manner using an audible indicator, such as an auditory device, with two different tones perceivable by the human operator, wherein one tone sounds when the comparison accept signal is outputted by the monitoring system 55 and a different tone sounds when the comparison reject signal is outputted.

For example, in one embodiment the desired category comprises sheets of material 10 of rectangular dimension of 24 inch length by 24 inch width. If the identifier 20 of the sheet of material 10 read by the monitoring system 55 provides a result indicating that the sheet of material 10 has dimensions of 16 inch length by 16 inch width, then the sheet of material 10 provided would be determined to not relate to the category (i.e., to fall outside of the category) and a comparison reject signal is output and the operation of the article forming system 52 is modified. For example, the article forming system 52 may be shut down until sheets of material 10 having 24 inch length by 24 inch width dimensions are provided. Alternatively, the article forming system 52 can be re-configured to produce a pot cover 30 requiring a sheet of material 10 which has dimensions of 16 inch length by 16 inch width.

In another example, in another embodiment, the category includes sheets of material 10 made of polypropylene film with a heat activated adhesive disposed thereon, wherein the heat activated adhesive requires application of heat of a minimum predetermined temperature, and therefore the article forming system 52 is configured to apply heat of the minimum predetermined temperature for forming articles from the sheet of material 10. If the identifier 20 indicates that the sheet of material 10 provided is made of, for example, metal foil not having a heat activated adhesive thereon, then the sheet of material 10 provided would be determined to not relate to the category (i.e., falls outside of the category) and the operation of the article forming system 52 would be modified. For example, operation of the article forming system 52 could be retarded until the correct sheet of material 10 could be provided. In an embodiment wherein the temperature setting of the article forming system 52 must be reconfigured, the resetting of the temperature and processing time appropriate for the sheet of material 10 provided can be, for example, performed by a human operator or automatically by a computer program using the result.

The above examples, or examples provided elsewhere herein, should be seen as illustrative only, and not as limiting the scope of the present invention, particularly regarding the use of the result in configuring the article forming system 52.

The step of modifying the operation of the article forming system 52 may include disabling the assembly 60 of the article forming system 52 to prevent the article forming system 52 from using the sheet of material 10 when the sheet of material 10 does not relate to the category. Additionally, if the step of modifying the operation of the article forming system 52 includes configuring the article forming system 52, disabling the forming device 60 allows the article producer to configure the article forming system 52 under safer conditions since generally any mechanical and electrical components (not shown) of the article forming system 52 are restricted from operating. The article forming system 52 may be disabled by any mechanical, electrical, or computational mechanism, or combination thereof, capable of restricting the functioning of the article forming system 52 so as to prevent the article forming system 52 from forming sheets of material 10 into flower pot covers 30, or any other item able to be so produced. For example, if the article forming system 52 includes a vacuum, blower, or air pressure source, then the article forming system 52 may be mechanically disabled by removing or turning off the vacuum, blower, or air pressure source. In another example, if the article forming system 52 includes a mechanically operational element, such as for example a die press shaft or cylinder, then the article forming system 52 may be mechanically disabled by immobilizing the die press shaft or cylinder, for example by using a physical restraint, such as a bar, which restricts the die press shaft or cylinder from moving in a downward direction. Further, if for example the article forming system 52 includes a power supply which supplies electrical power to the article forming system 52, then the article forming system 52 may be electrically disabled by removing or interrupting the power supply. The power supply can be removed or interrupted for the entire article forming system 52, or for portions thereof, such as for example to an electrically driven conveyor belt. Additionally, if the article forming system 52 preferably includes a computer which controls the operations of the article forming system 52, then the article forming system 52 could be computationally disabled, for example, by causing the computer to control the article forming system 52 so as to prevent the article forming system 52 from using the sheet of material 10. Further, if the article forming system 52 includes a means to automatically disable the article forming system 52, such as for example, an inherent emergency shut off mechanism, then such emergency shut off mechanism could also be used to disable the article forming system 52 when the sheet of material 10 does not relate to the category.

In one preferred embodiment, when the step of modifying the operation of the article forming system 52 comprises outputting the result, as discussed above, the step of modifying the operation of the article forming system 52 further comprises disabling the article forming system 52, as discussed above, after the determination mechanism 84 of the monitoring system 55 outputs the result. This allows for the result to be used, for example by a computer program or human operator, in disabling the article forming system. For example, when the result is a comparison reject signal and is outputted to at least one computer, a computer program of the at least one computer can be used to trigger the disabling of the article forming system 52. In another example, the result, e.g., as a comparison accept signal or comparison reject signal, may be outputted to at least one output device 94, such as an LED display in the same manner as discussed above. If the human operator perceives that the LED is emitting green light for example, and therefore that a comparison accept signal was outputted by the monitoring system, then the human operator will not need to disable the article forming system 52. If, however, the human operator perceives that the LED is emitting red light, for example, and therefore that a comparison reject signal was outputted by the monitoring system, then the human operator will disable the article forming system 52. The above example using the LED display could also be done in a like manner using the audible indicator in the same manner as discussed above. The above examples should be seen as illustrative only, and not as limiting the scope of the present invention. Other embodiments of using the determination information in disabling the article forming system 52 are apparent to one of ordinary skill in the art.

The monitoring system 55 of the article forming system 52 may output a disablement signal when the assembly 60 is disabled. The disablement signal, which may be proximate or remote, serves to indicate that the article forming system 52 has been disabled. The disablement signal may be outputted by the monitoring system 55 via signal path 106 of the output signal path 86 to at least one computer 90 (which may be remote) and/or to at least one output device 94, such as a printer, monitor, or any perception device capable of generating an audible, or electronic visual response thereto, such as an LED or speaker so as to give notice, for example to the article producer and/or another remote entity, that the article forming system 52 has been disabled. The entity may be, but is not limited to, a person, corporation, company, partnership, or limited liability company.

In one preferred embodiment, once the article forming system 52 has been disabled and/or configured or reconfigured appropriately, the article forming system 52 can be re-enabled so as to allow the article forming system 52 to use sheet of material 10. The article forming system 52 may be re-enabled by removing any restrictions on the functioning of the article forming system 52 caused by the mechanical, electrical, or computational mechanism used to restrict the functioning of the article forming system 52, as discussed above. In one preferred embodiment, in order to re-enable the article forming system 52, the article forming system 52 must be provided with a predetermined enable instruction. In one preferred embodiment, the predetermined enable instruction is a predetermined code having a sequence of alphanumeric characters which is provided to the monitoring system 55. The predetermined enable instruction can be provided to the monitoring system 55 from at least one local or remote input device 120 capable of providing the predetermined enable instruction, such as for example a telephone, computer, fax, remote control, keyboard, keypad, joystick, a pointing device, such as a mouse, or any combination or derivation thereof. For example, the input device 120 can be a keypad (not shown) so that the alphanumeric characters of the code can be provided, for example by the article producer or entity, to the monitoring system 55. The predetermined enable instruction may be provided from the input device 120 via an input signal path 124. In another example, the predetermined enable instruction may be provided to the monitoring system 55 using a local or remote computer or telephone (not shown) in order to re-enable the article forming system 52. The input signal path 124 can be, but is not limited to, a communication link such as an internet connection, intranet connection, cables, bus, cable network modem, telephone link, network connection, airway link, satellite link, radio link, local area network, wide area network, point-to-point shared and dedicated communication, infra-red link, microwave link, CATV link, fibre-optic link, and combinations or derivations thereof.

In one preferred embodiment, the monitoring system 55 further comprises a counting mechanism 130 for counting sheets of material 10. The counting mechanism 130 preferably uses data of the monitoring system 55 determining the presence or absence of the identifier 20, reading the identifier 20 of the sheet of material 10, and/or determining whether the sheet of material 10 relates to the category to count the number of sheets of material 10 sensed and/or read by the monitoring system 55, the number of sheets of material 10 which were determined by the monitoring system 55 to relate to the category, the number of sheets of material 10 which were determined by the monitoring system 55 to not relate to the category, and/or the number of sheets of material which were determined by the monitoring system 55 to be absent an identifier 20 disposed thereon or therein. In one embodiment, such as shown in FIG. 6, the counting mechanism 130 uses the result (e.g., the comparison accept signal and the comparison reject signal) outputted on signal lines 102 and 104 respectively to count the number of sheets of material 10 which were determined by the monitoring system 55 to relate to the category, the number of sheets 10 which were determined to not relate to the category, and the number of sheets of material absent the identifier 20. Such accounting information can be outputted by the counting mechanism 130 via a signal line 107 of output signal line 86 to at least one computer 90 and/or to at least one output device 94, or to any other device for utilizing or displaying the accounting information derived from the counting mechanism 130.

The counting mechanism 130 allows for a convenient method for the user of the present invention, such as for example the article producer or entity, to calculate the number of sheets 10 provided and thus, the number of flower pot covers 30 or other items formed from the sheets of material 10 by the article forming system 52. The accounting information can also be used, for example by a entity, to determine the number of articles formed from sheets of material absent the identifier 20.

In an alternate embodiment, the counting mechanism 130 can use data of the sheet of material 10 independently of the operation of the reading mechanism 62 of the monitoring system 55 to obtain a direct count of the number of sheets of material 10 provided to the forming device 130.

In one embodiment, the monitoring system 55 may further include a displaying mechanism 164 for displaying an image (not shown) representing at least a portion of the identifier 20 of the sheet of material 10 that is read by the reading mechanism 62 of the monitoring system 55 (or an image indicating that the identifier 20 is absent). The displaying mechanism 164 may comprise, for example, a photographic device 170 and a display device 174. The photographic device 170 is capable of generating the image representing the identifier 20 (or absence thereof) and communicates the image via an image signal path 178 to the display device 174 so that the display device 174 can display the image in a visual manner. The display device 174 may be proximate, or remote.

The photographic device 170 can be, but is not limited to, a video camera, photographic camera, digital camera, image scanner, charge couple device, or combinations or derivations thereof. Such photographic devices are well known to those of ordinary skill in the art as being capable of generating images, therefore no further discussion of their operation is deemed necessary herein.

The display device 174 can be, but is not limited to, a television, monitor, LCD, flat screen, printer, copier, photographic film, or combinations or derivations thereof. Such display devices are well known by those of ordinary skill in the art as being capable of displaying images, therefore no further discussion of their operation is deemed necessary herein. The image signal path 178 between the display device 174 and the photographic device 170 can be, but is not limited to, a communication link such as an internet connection, intranet connection, cable, bus, cable network modem, telephone link, network connection, airway link, satellite link, radio link, local area network, wide area network, point-to-point shared and dedicated communication, infra-red link, microwave link, CATV link, fibre-optic link, or combination or derivation thereof.

The displaying mechanism 164 for displaying the image allows for a visual inspection of the identifier 20 of the sheet of material 10 read by the monitoring system 55 (or absence thereof) to be performed locally and/or remotely by the user, which may be the article producer and/or the entity. In one embodiment, the displaying mechanism 164 is triggered by the determination of the presence or absence of the identifier 20 by the reading mechanism 62, whereby the displaying mechanism 164 generates the image of the identifier 20 or an image which indicates the absence of the identifier 20 when the reading mechanism 62 determines the presence or absence the identifier 20.

Additionally, the displaying mechanism 164 of the monitoring system 55 may further comprise a recording mechanism 182 for recording the image. In this embodiment, the photographic device 170 further communicates the image via the image signal path 178 to the recording mechanism 182 so that the recording mechanism 182 can record the image representing the identifier 20 (or absence thereof). The recording mechanism 182 preferably comprises a recording device such as for example a video cassette recorder, digital video disk burner, magnetic disk drive, photographic camera, digital camera, optical disk drive, hard disk drive, printer, copier, or combinations or derivations thereof, and a storage medium such as for example a video cassette, digital video disk, magnetic disk, photographic film, flash memory card, compact disk, hard disk, paper, or combinations and derivations thereof, in or upon which the image is stored. The recording mechanism 182 enables the recordation of the image of at least a portion of the identifier 20 read by the monitoring system 55 (or the absence of an identifier 20 being disposed on or in the sheet of material 10). Such recordation by the recording mechanism 182 can be utilized as data for further analysis of the sheet of material 10, such as for example by a human monitor in performing a visual inspection during real time or at a later time, by a computer program in analyzing the identifier 20, or by the monitoring system 55 in determining if the sheet of material 10 relates to the category.

In one embodiment of the present invention, the monitoring system 55 can further output an error signal via a signal path 108 of output signal path 86 to at least one computer 90 and/or to at least one output device 94 if the monitoring system 55 is disabled or is not otherwise functioning properly. For example, the monitoring system 55 can output an error signal if the monitoring system 55 is not able to do at least one of the following: sense the presence or absence of the identifier 20 of the sheet of material 10, read the identifier 20 of the sheet of material 10 when the identifier 20 is present, determine whether the identifier information interpreted by the reading mechanism 62 indicates that the sheet of material 10 relates to a category in a predetermined manner, cause the modification of the operation of the article forming system 52 when the information of the identifier 20 indicates that the sheet of material 10 does not relate to the category or when the sheet of material 10 is absent an identifier 20, count the sheets of material 10, or display or record the image of the identifier 20 (or absence thereof).

Referring now to FIG. 7, shown therein is a controlled article forming system 52a constructed in accordance with the present invention. The article forming system 52a is adapted to form at least one sheet of material 10 into an article, such as the flower pot cover 30. Broadly, the article forming system 52a includes a forming device 60a, a monitoring system 55a, and a computer 90a.

The forming device 60a shown in FIG. 7 comprises a female die 304a, and a male die 308a. The female die 304a is characterized as having an upper end 316a, a lower end 318a, and an opening 320a formed through the upper end 316a of the female die 304a extending a distance generally toward the lower end 318a of the female die 304a. The opening 320a is defined by a female die surface 322a.

The female die surface 322a includes a base portion 324a having an upper end and a lower end. The base portion 324a generally is frusto-conically shaped, thus the diameter of the base portion 324a generally near the lower end thereof is smaller than the diameter of the base portion 324a generally near the upper end thereof. The female die surface 322a also includes a flared portion 328a having an upper end and a lower end. The flared portion 328a extends angularly outwardly and upwardly from the upper end of the base portion 324a.

The female die 304a is provided with a plurality of openings 330a formed in the female die surface 322a. The openings 330a are connected to a blower 332a such that fluid communication is established between the openings 330a and the blower 332. A control valve 334a is interposed between the blower 332a and the openings 330a. In one position of the control valve 334a, communication is established between the blower 332a and the openings 330a in the female die 304a.

A heater element 336a is secured to the lower end 318a of the female die 304a to heat the female die surface 322a to a predetermined temperature level during the operation of the article forming system 52a. The heater element 336a is connected to an electrical power source 338a. A temperature sensing device (not shown) is positioned in the female die 304a and connected to the electrical power source 338a to sense the temperature level of the female die surface 322a and maintain the temperature level of the female die surface 322a at a desired predetermined temperature level.

The female die 304a is provided with a horizontal support surface 340a which circumscribes the opening 320a of the female die 304a. The support surface 340a includes four circumferentially spaced material holddown areas 342a (only one of the material holddown areas 342a being designated by reference numerals in FIG. 7). Each material holddown area 342a is provided with a plurality of openings 344a (only one of the openings 344a being designated by reference numerals in FIG. 7) which are in communication with a vacuum source 346a. A control valve 348a is interposed between the openings 344a and the vacuum source 346, the vacuum source 346a being in communication with the openings 344a in the support surface 340a in the opened position of the control valve 348a.

The male die 308a is shaped and sized to formingly mate with the female die 304a with a sufficient clearance therebetween to accommodate portions of the sheet or sheets of material 10 during the forming of an article, such as the flower pot cover 30. The male die 308a is characterized as having an upper end 350a, a lower end 352a, and a male die surface 354a. The male die surface 354a extends a distance generally from the lower end 352a toward the upper end 350a of the male die 308a. A portion of the male die surface 356a forms a base portion 358a of the male die surface 354a. The base portion 358a of the male die surface 354a has an outer peripheral surface which has a shape substantially the same as an outer peripheral surface of a flower pot. The dimensions of the base portion 358a are slightly larger than the comparable dimensions of the outer peripheral surface of the flower pot so that the flower pot cover 30 formed by the article forming system 52a of the present invention will fit generally about the outer peripheral surface of the flower pot (not shown) when the flower pot cover 30 is disposed about the flower pot.

The base portion 358a has an upper end and a lower end. The lower end of the base portion 358a coincides with and forms the lower end 352a of the male die 308a. Thus, the base portion 358a of the male die surface 354a generally is frusto-conically shaped with the diameter of the base portion 358a generally at the lower end being smaller than the diameter of the base portion 358a generally at the upper end of the base portion 358a. The male die surface 354a also includes a flared portion 362a which flares a distance angularly outwardly and upwardly from the upper end of the base portion 358a. The flared portion 362a of the male die surface 354a is characterized as having an upper end and a lower end with the lower end thereof being connected to the upper end of the base portion 358a.

A plurality of openings 364a (only two openings 364a being designated by a reference numeral in FIG. 7) are formed through the male die 308a with each opening 364a extending through the male die surface 354a. The openings 364a are connected to the blower 332a and the vacuum source 346a such that fluid communication is established between the openings 364a and the blower 332a and the openings 364a and the vacuum source 346a. A control valve 366a is interposed between the vacuum source 346a and the openings 364a. In one position of the control valve 366a, communication is established between the vacuum source 346a and the openings 364a in the male die 308a, and in one position of the control valve 366a communication is established between the blower 332a and the openings 364a.

A heater element 368a is secured to the upper end 350a of the male die 308a to heat the male die surface 354a to a predetermined temperature level during the operation of the article forming system 52a. The heater element 368a is connected to the electrical power source 338a. A temperature sensing device (not shown) is positioned in the male die 308a and connected to the electrical power source 338a to sense the temperature level of the male die surface 354a and maintain the temperature level of the male die surface 354a at a desired predetermined temperature level. The male die 308a and the heater element 368a are adapted to receive a plunger assembly 370a for assisting in the removal of a formed article from the male die 308a.

The male die 308a is supported above the female die 304a by a cylinder 372a whereby the male die 304a is movable between a discharge position and a forming position (not shown). In the discharge position, the male die 308a is removed from the female die 304a so that the sheet of material 10 can be fed or placed into the forming device 60a of the article forming system 52a generally along a feed path 374a and positioned between the male die 308a and the female die 304a and so that a formed article, such as the flower pot cover 30, is readily removable from the male die 308a. The sheet of material 10 can be moved along the feed path 374a by a web assembly, conveyor system, or a human operator (not shown), for example or any other method known in the art.

In the forming position, the male die 308a is matingly disposed into the female die 304a. The cylinder 372a is mounted to a support frame 376a, and the cylinder 372a has a reciprocating rod 378a which has one end connected to the heater element 368a. To assist in stopping the male die 308a when the male die 308a is traveling from the discharge position to the forming position, the cylinder 372a is provided with a pneumatically operated brake or locking device 380a which is frictionally engagable with a portion of the rod 378a for stopping the male die 308a. A control valve 382a is interposed between a pressurized air source 384a and the locking device 380a. In one position of the control valve 382a, communication is established between the pressurized air source 384a and the locking device 380a to cause the locking device 380a to lockingly engage the rod 378a. A suitable double acting lock cylinder is commercially available for example from SMC Corporation of Tokyo, Japan.

The computer 90a in a preferred embodiment controls the operation of the article forming system 52a, for example by controlling the opening and closing of control valves 334a, 348a, 366a, and 302a and/or the temperature of heating elements 336a and 368a of the forming device 60a. The computer 90a can for example be a controller.

A reading mechanism 62a of the monitoring system 55a is preferably positioned near or adjacent to the feed path 374a of the sheet of material 10 so that the reading mechanism 62a can sense the sheet of material 10 and detect and read the identifier 20 of the sheet of material 10 as the sheet of material 10 is moved along feed path 374a. In a preferred embodiment, the reading mechanism 62a is positioned near or adjacent to the feed path 374a such that the reading mechanism 62a of the monitoring system senses the sheet of material 10 and reads the identifier 20 before the forming device 60a of the article forming system 52a forms the sheet of material 10 into the pot cover 30, or other article.

However, the reading mechanism 62a can also be positioned such that the reading mechanism 62a senses the sheet of material and reads the identifier 20 of the sheet of material 10 during or after the forming device 60a forms the sheet of material 10 into an article. Further, the position of the reading mechanism 62a may be fixed, adjustable, stationary, dynamic, or combinations thereof with respect to the feed path 374a. For example, the reading mechanism 62a of the monitoring system 55a could for example be a hand-held device, such as a portable wand scanner or laser reader (not shown), which is movable within the article forming system 52a by a human operator.

Alternatively, the reading mechanism 62a may be permanently stationed, or the reading mechanism 62a may be attached to a hinged arm adjustable between a range of positions or moveable to predetermined positions, or the reading mechanism 62a could be rotating about the feed path 374a, for example. Further, the reading mechanism 62a may include one or more spacial locations. For example, the reading mechanism 62a could comprise two or more bar code scanners with each bar code scanner positioned at different spacial locations.

In one embodiment, as shown for example in FIG. 7, the reading mechanism 62a of the monitoring system 55a is positioned a distance away from and adjacent to the forming device 60a of the article forming system 52a. The reading mechanism 62a is supported above the feed path 374a of the sheet of material 10 by a vertical support beam 390a mounted to and extending downward from the support frame 376a. Also, as shown for example in FIG. 7, the monitoring system 55a can include a displaying mechanism 164a having a photographic device 170a positioned adjacent to the reading mechanism 62a. Although the photographic device 170a is shown as positioned adjacent to the reading mechanism 62a, it should be understood that the photographic device 170a can also be positioned remote from the reading mechanism 62a. Further, the reading mechanism 62a of the monitoring system 55a in one preferred embodiment is positioned remotely from the determination mechanism 84a, however it should be understood that the reading mechanism 62a can also be positioned adjacent to the determination mechanism 84a of the monitoring system 55a. Also, the monitoring system 55a can include a counting mechanism, as previously discussed regarding FIG. 6 but which is not shown.

In alternative embodiments, the reading mechanism 62a may be positioned upon a portion of the forming device 60a, for example on or in the female die 304a or on or in the male die 308a. Furthermore, a person of ordinary skill in the art would recognize that the reading mechanism 62a can be positioned at any location remote from, adjacent to, or within or upon the forming device 60a or in the article forming system 52a as long as the reading mechanism 62a functions in accordance with the present invention.

Additional examples of applications of the apparatus and method of the present invention are set forth hereinafter. The examples are intended to illustrate how the apparatus and method of the present invention can be applied to or incorporated into various other article forming systems, and methods of using the same, which are well known in the art, or derivations thereof, as one of ordinary skill in the art would recognize other applications or incorporations of the present invention into other article forming systems. It is to be understood that the examples are for illustrative purposes only and are not to be construed as limiting the scope of the invention as described and claimed elsewhere herein.

### EXAMPLE 1

One article forming system which is well known in the art in shown in U.S. Pat. No. 4,773,182, issued to Weder et al., which is hereby expressly incorporated herein by reference in its entirety. The '182 patent discloses an article forming system having a female die, and a male die connected to a rod reciprocatingly disposed in a hydraulic cylinder which moves the male die in a downward/forming and an upward/storage position.

The article forming system of the '182 patent, which has forming device 60 (including the male and female dies) for forming the sheet of material 10 into the flower pot cover 30, can be provided with the monitoring system 55 in accordance with the present invention. If a sheet of material 10 having the identifier 20 thereon or therein is provided and the monitoring system 55 determines that sheet of material 10 does not relate to the category, or the sheet of material is absent the identifier 20, then the operation of the article forming system 52 can be modified in accordance with the present invention.

For example, in a scenario wherein the category includes a sheet of material whose source is a particular entity, and the sheet of material 10 provided to the article forming system 52 does not have the identifier 20 disposed thereon or therein, the monitoring system 55 will determine that the sheet of material 10 is absent the identifier 20. The article forming system 52 will then be modified, for example by the monitoring system 55 outputting a comparison reject signal to a computer of the entity and/or by the monitoring system 55 causing a computer controlling the forming device 60 of the article forming system 52 to control the hydraulic cylinder of the article forming system 52 to move the male die to the storage position and hold the male die in the storage position so as to disable the article forming system 52 until a predetermined enable instruction is provided to the monitoring system 55. The entity can provide the predetermined enable instruction to the monitoring system 55 once it is satisfied that the article forming system 52 has been configured appropriately to produce the flower pot covers 30 with appropriate sheets of material 10. Once the predetermined enable instruction is provided, the article forming system 52 can be re-enabled by allowing the hydraulic cylinder to move the male die, thereby allowing the article forming system 52 to resume forming flower pot covers 30 from appropriate sheets of material 10.

Such features of the present invention would be beneficial to ensure that sheets of material 10 provided to the article forming system 52 are made by or obtained from a particular qualified source. For example, the entity, such as a licensor or corporate home office, can use the present invention to determine the presence or absence of an identifier 20 identifying the particular source of the sheet of material 10. In such an example, the entity, can maintain quality control in the flower pot cover 30, or other article being formed, by ensuring that the sheets of material 10 which are used are provided by or authorized by the entity, and thereby protecting the interest of the entity, for example, by preserving the quality of the flower pot cover 30 having trademark status or by reducing possible liability by producing defective products.

### EXAMPLE 2

Another article forming system well known in the art includes the cover forming apparatus shown in U.S. Pat. No. 4,733,521, issued to Weder et al., which is hereby expressly incorporated herein by reference in its entirety. In the '521 patent, the cover forming apparatus is constructed and adapted to form a sheet of material about an object, such as a flower pot, to produce a cover. The sheet of material can be adhered to the object using a bonding material, such as an adhesive disposed on the sheet of material or banding element applied by use of a banding apparatus, which may be operated by a human operator or a band applicator such as shown in U.S. Pat. No. 5,105,599, issued to Weder, which is hereby expressly incorporated herein by reference in its entirety.

The cover forming apparatus of the '521 patent, which has the forming device 60 for forming the sheet of material 10 into the flower pot cover 30, can further be provided with the monitoring system 55 in accordance with the present invention. When the sheet of material 10 is determined by the monitoring system 55 to not relate to the category or have an identifier 20, the operation of the article forming system 52 can be modified. For example, in one embodiment the flower pot cover 30 which is desired by the article producer must be formed from a water-impermeable material and formed about a floral holding material to form a flexible vase, (such as shown for example in U.S. Pat. No. 6,516,564, issued to Weder et al., which is hereby expressly incorporated herein by reference in its entirety). In this example, use of a water-impermeable material is important because the cover enables a water reservoir to be provided to a floral grouping disposed in the flexible vase. For example, if the sheet of material 10 used by the apparatus is made of a material which is not water-impermeable, such as for example a porous sheet of material 10, the monitoring system 55 would determine that the sheet of material 10 does not relate to the category and the operation of the article forming system 52 would be modified, for example by removing the porous sheet of material 10 from the article forming system 52 or by shutting down the article forming system 52 until appropriate sheets of material 10 can be provided.

### EXAMPLE 3

Another article forming system well known in the art is the cover forming apparatus shown in U.S. Pat. No. 6,502,368, issued to Grether, which is hereby expressly incorporated herein by reference. In the '368 patent, a sheet of material is disposed between a former and a flower pot such that as the flower pot is passed into the former, the sheet of material is formed about the flower pot and loops are positioned by an individual, a human operator, to secure the sheet of material about the flower pot.

The cover forming apparatus of the '368 patent, which has a forming device 60 (which includes the former, flower pot, and loops) for forming the sheet of material 10 into the flower pot cover 30, can further be provided with the monitoring system 55 in accordance with the present invention. If the monitoring system 55 determines that the sheet of material 10 provided does not relate to the category, the operation of the article forming system 52 is modified, for example by monitoring system outputting the comparison reject signal to a red LED, as described above, so as to visually alert the operator of the article forming system 52 that the sheet of material 10 was determined to not relate to the category. Then the operator could remove the sheet of material 10 from the former and proceed to use another sheet of material 10.

For example, in one embodiment the identifier 20 may indicate that the sheet of material 10 has a pattern of a red background with white hearts and has a heat activated adhesive disposed thereon. However, assume that the predetermined desired category includes sheets of material having a pattern of a red background with white stars (rather than white hearts) and is to be secured about a pot via a ribbon (rather than an adhesive) because the user, an article producer, wants to fulfill a particular customer order for flower pots covered with a flower pot cover 30 that is red with white stars and is banded only by a ribbon. Additionally, assume the article producer is using a cover former which does not have a heat source. In the above example, if an uninformed employee of the article producer were to use sheets of material 10 which are red with white hearts and have a heat-activated adhesive disposed thereon, undesired products would be produced causing waste of materials, and delays in the filling of the order, possibly resulting in higher costs and/or a displeased customer. However, since the monitoring system 55 would determine that the sheet of material 10 provided does not relate to the category, the operation of the article forming system 52 could be modified before production, or early into production, thereby allowing for the correct flower pot covers 30 to be produced. For example, the operation of the article forming system 52 could be modified by the monitoring system outputting the comparison reject signal to a visual or audio display, as described above, and the employee could notify a supervisor so that a supervisor can determine whether the sheets of material 10 provided were incorrectly purchased by and delivered to the article producer, and that different sheets of material 10 should be provided to complete the order correctly.

From the above description, it is clear that the present invention is well adapted to carry out the objects and to attain the advantages mentioned herein as well as those inherent in the invention. While presently preferred embodiments of the invention have been described for purposes of this disclosure, it will be readily understood that numerous changes may be made which will readily suggest themselves to those skilled in the art and which are accomplished within the spirit of the invention disclosed.

1. A method for controlling the operation of an article forming system, the article forming system having a forming device for forming a sheet of material into an article having a predetermined shape and an inner space, the method comprising the steps of:
determining the presence or absence of an identifier on or in the sheet of material via a monitoring system, wherein the identifier encodes or comprises sheet information regarding the identity and/or characteristics of the sheet of material;
reading the identifier of the sheet of material via the monitoring system to obtain or interpret the sheet information from the identifier when the identifier is present on or in the sheet of material; and
modifying the operation of the article forming system when the sheet information obtained or interpreted from the identifier indicates that the sheet of material falls outside of a predetermined category, or when the sheet of material is absent an identifier.

2. The method of claim 1, wherein in the step of determining the presence or absence of an identifier, the identifier comprises at least one of a bar code, watermark, hallmark, logo, text, word, name, symbol, device, graphic, picture, seal, hologram, color code, magnetic code, chemical tag, nanobarcode, DNA tracer, stacked symbology, matrix symbology, or combinations thereof.

3. The method of claim 2, wherein the identifier further comprises at least one of an inscribed stamp, photo-luminescent dye, IR up-converter crystals, nanoparticles, laser light, magnetic ink, metallic ink, printing ink, color ink, DNA, chemical infusion, or combinations thereof.

4. The method of claim 1, wherein in the step of determining the presence or absence of an identifier, the identifier comprises a bar code and the monitoring system comprises at least one bar code scanner.

5. The method of claim 1, wherein in the step of determining the presence or absence of an identifier, the sheet information is indicative of at least one of the source, shape, dimension, coloring, pattern, material, bonding material, structural feature, potential use, or combinations thereof, of the sheet of material.

6. The method of claim 5, wherein the sheet information comprises encrypted data, and wherein the monitoring system is able to decode the encrypted data using predetermined decodation rules.

7. The method of claim 1, wherein in the step of modifying the operation of the article forming system, the monitoring system outputs a result based on the determination of the presence or absence of the identifier on or in the sheet of material, the sheet information read from the identifier, the category, the relation of the sheet of material to the category, or combinations thereof.

8. The method of claim 7, wherein the result outputted by the monitoring system comprises an accept signal indicating that the sheet of material falls within the category, or a reject signal indicating the absence of the identifier or that the sheet of material falls outside of the category.

9. The method of claim 7, wherein the result is outputted by the monitoring system via an output signal path to at least one computer.

10. The method of claim 9, wherein the output signal path is a communication link selected from the group consisting of internet connections, intranet connections, cables, buses, cable network modems, telephone links, network connections, airway links, satellite links, radio links, local area networks, wide area networks, point-to-point shared and dedicated communications, infra-red links, microwave links, CATV links, fibre-optic links, and combinations thereof.

11. The method of claim 1 wherein the step of interpreting the sheet information is performed by a computer remote from the article forming system.

12. The method of claim 8, wherein when the monitoring system outputs the reject signal, the step of modifying the operation of the article forming system comprises disabling the operation of the article forming system.

13. The method of claim 12, wherein the monitoring system further outputs a disablement signal when the article forming system is disabled.

14. The method of claim 13, wherein the disablement signal is outputted by the monitoring system via the output signal path to at least one computer.

15. The method of claim 12, comprising the additional step of re-enabling the article forming system after the article forming system has been disabled.

16. The method of claim 15, wherein the step of re-enabling the article forming system comprises providing a predetermined enable instruction to the monitoring system.

17. The method of claim 16, wherein the predetermined enable instruction is provided to the monitoring system via an input signal path from at least one device selected from the group consisting of telephones, computers, faxes, remote controls, keyboards, keypads, mouses, joysticks, and combinations thereof.

18. The method of claim 17, wherein the input signal path is a communication link selected from the group consisting of internet connections, intranet connections, cables, buses, cable network modems, telephone links, network connections, airway links, satellite links, radio links, local area networks, wide area networks, point-to-point shared and dedicated communications, infra-red links, microwave links, CATV links, fibre-optic links, and combinations thereof.

19. The method of claim 1, wherein the step of modifying the operation of the article forming system comprises altering the operating conditions of the article forming system.

20. The method of claim 1 comprising the additional step of counting at least a portion of the sheets of material and outputting a signal indicative of the count.

21. The method of claim 1, wherein in the step of determining the presence or absence of an identifier, the monitoring system further comprises a display mechanism for displaying an image of at least a portion of the sheet of material.

22. The method of claim 21, wherein the display mechanism comprises a photographic device and a display device, wherein the photographic device generates the image and communicates the image to the display device for visually displaying the image.

23. The method of claim 22 wherein the image comprises an image of the identifier.

24. The method of claim 22, wherein the photographic device is selected from the group consisting of video cameras, photographic cameras, digital cameras, image scanners, charge couple devices, and combinations thereof.

25. The method of claim 22, wherein the display device is selected from the group consisting of televisions, monitors, LCDs, flat screens, printers, copiers, photographic film, and combinations thereof.

26. The method of claim 22, wherein the photographic device is a digital or video camera and the display device is a television or monitor.

27. The method of claim 22, wherein the monitoring system further comprises a recording mechanism for recording at least a portion of the image generated by the photographic device.

28. The method of claim 27, wherein the recording mechanism comprises a recording device which records the image on a storage medium.

29. The method of claim 28, wherein the recording device is selected from the group consisting of video cassette recorders, digital video disk burners, magnetic disk drives, photographic cameras, digital cameras, optical disk drives, hard disk drives, printers, copiers, and combinations thereof.

30. The method of claim 28, wherein the storage medium is selected from the group consisting of video cassettes, digital video disks, magnetic disks, photographic film, flash memory cards, compact disks, hard disks, paper, and combinations thereof.

31. A controlled article forming system for forming an article, comprising:
an article forming system comprising a forming device for forming a sheet of material into an article having a predetermined shape and an inner space;
a monitoring system comprising a reading mechanism for determining the presence or absence of an identifier on or in the sheet of material and for reading the identifier, wherein the identifier encodes or comprises sheet information regarding the identity and/or characteristics of the sheet of material and wherein the reading mechanism of the monitoring system further interprets the sheet information of the identifier; and
wherein the monitoring system is able to modify the operation of the article forming system when the sheet information obtained from the identifier indicates that the sheet of material falls outside of a predetermined category, or when the sheet of material is absent an identifier.

32. The controlled article forming system of claim 31, wherein the identifier comprises at least one of a bar code, watermark, hallmark, logo, text, word, name, symbol, device, graphic, picture, seal, hologram, color code, magnetic code, chemical tag, nanobarcode, DNA tracer, stacked symbology, matrix symbology, or combinations thereof.

33. The controlled article forming system of claim 32, wherein the identifier further comprises at least one of an inscribed stamp, photo-luminescent dye, IR up-converter crystals, nanoparticles, laser light, magnetic ink, metallic ink, printing ink, color ink, DNA, chemical infusion, or combinations thereof.

34. The controlled article forming system of claim 32, wherein the identifier comprises a bar code and the monitoring system comprises at least one bar code scanner.

35. The controlled article forming system of claim 31, wherein the sheet information of the identifier is indicative of at least one of the source, shape, dimension, coloring, pattern, material, bonding material, structural feature, potential use, or combinations thereof, of the sheet of material.

36. The controlled article forming system of claim 35, wherein the sheet information of the identifier comprises encrypted data, and wherein the monitoring system is able to decode the encrypted data using predetermined decodation rules.

37. The controlled article forming system of claim 31, wherein the monitoring system is able to output a result based on the determination of the presence or absence of the identifier on or in the sheet of material, the sheet information read from the identifier, the category, the relation of the sheet of material to the category, or combinations thereof.

38. The controlled article forming system of claim 37, wherein the result outputted by the monitoring system comprises an accept signal indicating that the sheet of material falls within the category or a reject signal indicating the absence of the identifier or that the sheet of material falls outside of the category.

39. The controlled article forming system of claim 37, wherein the result is able to be outputted by the monitoring system via an output signal path to at least one computer.

40. The controlled article forming system of claim 39, wherein the output signal path is a communication link selected from the group consisting of internet connections, intranet connections, cables, buses, cable network modems, telephone links, network connections, airway links, satellite links, radio links, local area networks, wide area networks, point-to-point shared and dedicated communications, infra-red links, microwave links, CATV links, fibre-optic links, and combinations thereof.

41. The controlled article forming system of claim 31, wherein the monitoring system is able to modify the operation of the article forming system by altering the operating conditions of the article forming system.

42. The controlled article forming system of claim 38, wherein the monitoring system is able to modify the article forming system by disabling the operation of the article forming system when the monitoring system outputs the reject signal.

43. The controlled article forming system of claim 42, wherein the monitoring system is able to output a disablement signal when the article forming system is disabled.

44. The controlled article forming system of claim 43, wherein the disablement signal is able to be outputted by the monitoring system via the output signal path to at least one computer.

45. The controlled article forming system of claim 43, wherein the output signal path is a communication link selected from the group consisting of internet connections, intranet connections, cables, buses, cable network modems, telephone links, network connections, airway links, satellite links, radio links, local area networks, wide area networks, point-to-point shared and dedicated communications, infra-red links, microwave links, CATV links, fibre-optic links, and combinations thereof.

46. The controlled article forming system of claim 42, wherein the monitoring system further is able to modify the operation of the article forming system by re-enabling the article forming system afterthe article forming system has been disabled due to output of the reject signal.

47. The controlled article forming system of claim 46, wherein the article forming system can be re-enabled by providing a predetermined enable instruction to the monitoring system.

48. The controlled article forming system of claim 47, wherein the predetermined enable instruction can be provided to the monitoring system via an input signal path from at least one device capable of providing the predetermined enable instruction selected from the group consisting of telephones, computers, faxes, remote controls, keyboards, keypads, mouses, joysticks, and combinations thereof.

49. The controlled article forming system of claim 31, wherein the monitoring system is able to count at least a portion of the sheets of material and is able to output a signal indicative of the count.

50. The controlled article forming system of claim 31, wherein the monitoring system further comprises a display mechanism for displaying an image of at least a portion of the sheet of material.

51. The controlled article forming system of claim 50, wherein the displaying mechanism comprises a photographic device and a display device wherein the photographic device generates the image and communicates the image to the display device for visually displaying the image.

52. The controlled article forming system of claim 51, wherein the photographic device is selected from the group consisting of video cameras, photographic cameras, digital cameras, image scanners, charge couple devices, and combinations thereof.

53. The controlled article forming system of claim 51, wherein the display device is selected from the group consisting of televisions, monitors, LCDs, flat screens, printers, copiers, photographic film and combinations thereof.

54. The controlled article forming system of claim 51, wherein the photographic device is a digital or video camera and the display device is a television or monitor.

55. The controlled article forming system of claim 51, wherein the monitoring system further comprises a recording mechanism for recording at least a portion of the image, and the photographic device further communicates the image to the recording mechanism wherein the recording mechanism records the image.

56. The controlled article forming system of claim 55, wherein the recording mechanism comprises a recording device and a storage medium for recording the image on the storage medium.

57. The controlled article forming system of claim 56, wherein the recording device is selected from the group consisting of video cassette recorders, digital video disk burners, magnetic disk drives, photographic cameras, digital cameras, optical disk drives, hard disk drives, printers, copiers, and combinations thereof.

58. The controlled article forming system of claim 56, wherein the storage medium is selected from the group consisting of video cassettes, digital video disks, magnetic disks, photographic film, flash memory cards, compact disks, hard disks, paper, and combinations thereof.

59. The controlled article forming system of claim 31, wherein the reading mechanism of the monitoring system is positioned adjacent to the forming device of the article forming system.

60. The controlled article forming system of claim 31, wherein the reading mechanism of the monitoring system is positioned remote from the forming device of the article forming system.

61. The controlled article forming system of claim 31, wherein the reading mechanism of the monitoring system is positioned on the forming device of the article forming system.

62. The controlled article forming system of claim 31, wherein the reading mechanism of the monitoring system is positioned within the forming device of the article forming system.

63. The controlled article forming system of claim 31, wherein the monitoring system is able to output an error signal if the monitoring system is not able to sense the presence or absence of the identifier of the sheet of material, read the identifier of the sheet of material when the identifier is present, determine whether the sheet information interpreted by the reading mechanism indicates that the sheet of material falls within or outside of the predetermined category, or cause the modification of the operation of the article forming system when the sheet information indicates that the sheet of material falls outside of the predetermined category or when the sheet of material is absent an identifier.

64. A monitoring system for controlling the operation of an article forming system, the article forming system comprising a forming device for forming a sheet of material into an article having a predetermined shape and an inner space, the monitoring system comprising:
a reading mechanism for determining the presence or absence of an identifier on or in the sheet of material, the identifier encoding or comprising sheet information, and for reading the identifier of the sheet of material to obtain or interpret the sheet information, wherein the sheet information includes information regarding the identity and/or characteristics of the sheet of material; and
a determination mechanism for receiving the sheet information obtained or interpreted by the reading mechanism and for determining whether the sheet information indicates that the sheet of material falls within or outside of a predetermined category, and for causing the modification of the operation of the article forming system when the sheet information indicates that the sheet of material falls outside of the predetermined category, or when the sheet of material is absent an identifier.

65. A method for monitoring the operation of an article forming system, the article forming system comprising a forming device for forming a sheet of material into an article having a predetermined shape and an inner space, the method comprising the steps of:
determining the presence or absence of an identifier on or in the sheet of material via a monitoring system, wherein the identifier encodes or comprises sheet information regarding the identity and/or characteristics of the sheet of material;
reading the identifier of the sheet of material via the monitoring system to obtain or interpret the sheet information encoded by the identifier of the sheet of material when the identifier is present; and
outputting a signal to a computer remotely located from the article forming system when the sheet information read from the identifier indicates that the sheet of material falls outside of a predetermined category, or when the sheet of material is absent an identifier.

66. A method of providing a sheet of material for use in forming an article using a controlled article forming system, comprising:
providing a sheet of material having an identifier thereon or therein, wherein the identifier encodes or comprises sheet information regarding the identity and/or characteristics of the sheet of material, wherein the sheet of material is able to be used with an article forming system comprising a forming device for forming the sheet of material into an article having a predetermined shape and an inner space, wherein the article forming system comprises a monitoring system comprising a reading mechanism for determining the presence or absence of the identifier on the sheet of material and for reading the identifier to obtain or interpret the sheet information of the identifier, and wherein the monitoring system is able to modify the operation of the article forming system when the sheet information indicates that the sheet of material falls outside of a predetermined category; and
selling and delivering the sheet of material to a producer or seller of the article formed from the sheet of material wherein the producer or seller of the article uses the controlled article forming system to form the article from the sheet of material.

67. The method of claim 66 wherein in the step of providing a sheet of material, the sheet information is indicative of at least one of the source, shape, dimension, coloring, pattern, material, bonding material, structural feature, potential use, or combinations thereof, of the sheet of material.

68. The method of claim 66 wherein in the step of providing a sheet of material, the identifier comprises at least one of a bar code, watermark, hallmark, logo, text, word, name, symbol, device, graphic, picture, seal, hologram, color code, magnetic code, chemical tag, nanobarcode, DNA tracer, stacked symbology, matrix symbology, or combinations thereof.
